(19) United States
(12) Patent Application Publication
(10) Pub. No.: US 2010/0005327 A1
(43) Pub. Date: Jan. 7, 2010

(54) USB HOST CONTROLLER, INFORMATION PROCESSOR, CONTROL METHOD OF USB HOST CONTROLLER, AND STORAGE MEDIUM

(75) Inventor: Naoya Murata, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/433,228

(22) Filed: Apr. 30, 2009

(30) Foreign Application Priority Data
Jul. 2, 2008 (JP) 2008-173822

(51) Int. Cl. G06F 1/32

(52) U.S. Cl. 713/320

(57) ABSTRACT

A USB host controller includes: a suspend signal generating unit configured to generate a suspend signal for stopping the operation of a PLL circuit and output the signal to a physical layer including the PLL circuit if there is no communication between a USB device and a CPU in a first mode state of using a clock signal generated by the PLL circuit to transfer data between the USB device and the CPU; and a controller configured to generate the suspend signal for stopping the operation of the PLL circuit and output the signal to the physical layer in a connection waiting state in which the USB device is not connected and in a second mode state of transferring the data between the USB device and the CPU without using the clock signal generated by the PLL circuit.

### CROSS REFERENCE TO RELATED APPLICATION

This application is based upon and claims the benefit of priority from the prior Japanese Patent Application No. 2008-173822 filed in Japan on Jul. 2, 2008; the entire contents of which are incorporated herein by reference.

### BACKGROUND OF THE INVENTION

1. Field of the Invention

The present invention relates to a USB host controller, an information processor, a control method of the USB host controller, and a storage medium, and particularly, to a USB host controller, an information processor, a control method of the USB host controller, and a storage medium configured to control the operation of a PLL circuit of a physical layer of the USB host controller.

2. Description of the Related Art

Conventionally, the USB has been widely used as one of the standards of a serial bus for connecting a device, such as a computer, and a peripheral device.

A USB 2.0 host controller configured to support a High Speed mode compliant with a USB 2.0 standard as one of the USB standards and an EHCI standard as a standard of the USB 2.0 host controller is constituted of a digital layer (hereinafter, also called “Link section”) and a physical layer (hereinafter, also called “PHY section”). A PLL circuit is mounted on the PHY section to generate a serial data clock signal in a High Speed (480 MHz) mode. The power consumption of the PLL circuit accounts for much of the power consumption in the Link section and the PHY section of the USB 2.0 host controller.

Shifting to a suspended state defined in the USB 2.0 standard is necessary to shift the PLL circuit to a low power consumption state.

However, the suspended state is only effective in a state in which a USB device is connected and in an idle state in which there is no data to be transferred on a bus of the USB. Therefore, conventionally, the PLL circuit could not be shifted to a low power consumption state if the USB 2.0 host controller is in a state other than the suspended state.

This is because, for example, when the USB device is not connected, a clock generated in the PLL circuit is necessary to detect that the USB device is connected to the USB 2.0 host controller, even if the power is supplied to the USB 2.0 host controller.

A technique for reducing the power consumption in a state other than the suspended state is also proposed. For example, Japanese Patent Application Laid-Open Publication No. 2006-344159 proposes a technique capable of stopping clocks in a USB device in a transfer state.

However, the proposed technique is designed to save the power of the USB device, not the power of the USB host controller.

Furthermore, Japanese Patent Application Laid-Open Publication No. 2005-182385 and a document “SYNOPSYS, INC., AppNote For DesignWare LEGACY USB 2 PHY HARD MACRO AGGRESSIVE LOW POWER, October 2007” propose a technique for disabling a reception circuit before the USB cable connection and a technique for activating a suspend signal to a PHY section in a state of waiting for the USB device connection.

However, the former is not designed to save power of the PLL circuit, and the latter is designed to save power of the PLL circuit only in the state of waiting for the USB device connection.

### BRIEF SUMMARY OF THE INVENTION

An aspect of the present invention can provide a USB host controller including: a power saving control circuit configured to generate a predetermined signal for stopping the operation of a PLL circuit and output the signal to a physical layer including the PLL circuit if there is no communication between a USB device and a CPU in a first mode state of using a clock signal generated by the PLL circuit to transfer data between the USB device and the CPU; and a control circuit configured to generate the predetermined signal for stopping the operation of the PLL circuit and output the signal to the physical layer in a connection waiting state in which the USB device is not connected and in a second mode state of transferring the data between the USB device and the CPU without using the clock signal generated by the PLL circuit.

### BRIEF DESCRIPTION OF THE DRAWINGS

FIG. 1 is a block diagram of a configuration of an information processor including a USB host controller according to a first embodiment of the present invention;

FIG. 2 is a block diagram of an internal configuration of the USB host controller according to the first embodiment of the present invention;

FIG. 3 is a state transition diagram for explaining a state transition in a state machine unit according to the first embodiment of the present invention;

FIG. 4 is a flow chart of an example of a flow of power saving control of the USB host controller in the information processor according to the first embodiment of the present invention;

FIG. 5 is a block diagram of an internal configuration of a USB host controller according to a second embodiment of the present invention; and

FIG. 6 is a flow chart of an example of a flow of a power saving control of an information processor according to the second embodiment of the present invention.

### DETAILED DESCRIPTION OF THE EMBODIMENTS OF THE INVENTION

Embodiments of the present invention will now be described with reference to the drawings.

### First Embodiment

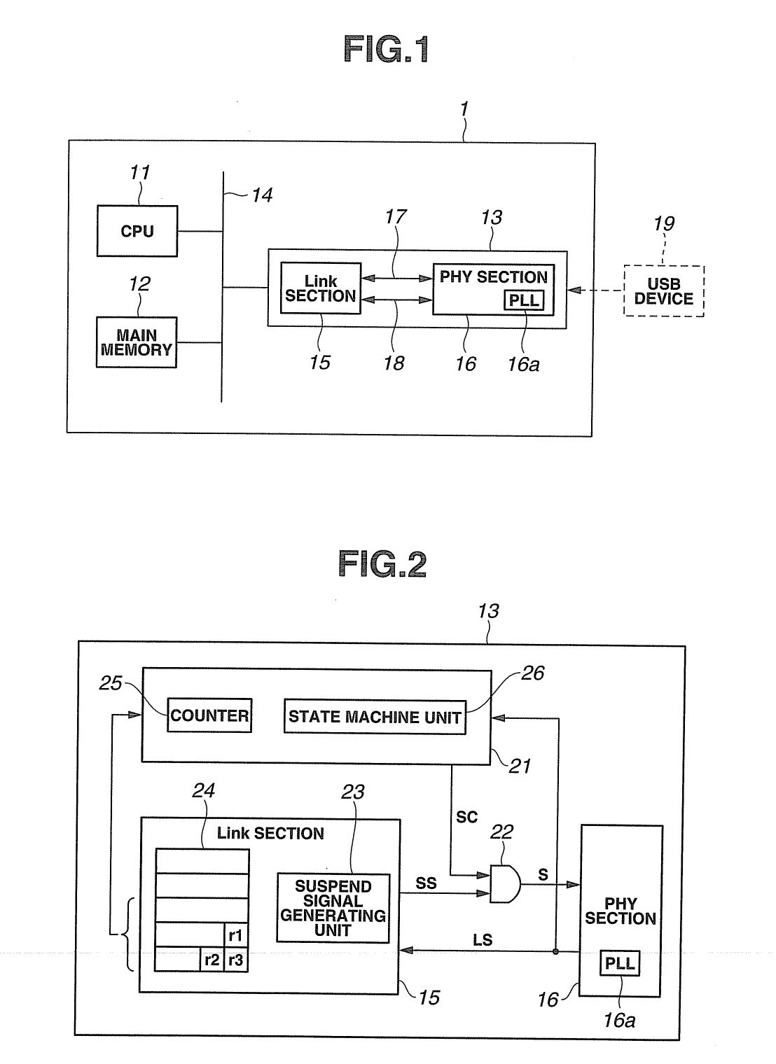

A configuration of an information processor including a USB host controller according to a first embodiment of the present invention will be described first based on FIG. 1. FIG. 1 is a block diagram of a configuration of an information processor including a USB host controller according to the present embodiment.

As shown in FIG. 1, a personal computer (hereinafter “PC”) 1 as an information processor includes a central processing unit (CPU) 11, a main memory 12, and a USB host controller 13, and the CPU 11, the main memory 12, and the USB host controller 13 are connected to each other through an internal bus 14. The USB host controller 13 herein is a USB 2.0 host controller.

The USB host controller 13 includes a Link section 15 as a digital layer and a PHY section 16 as a physical layer. The Link section 15 and the PHY section 16 are connected by a serial interface 17 and a parallel interface 18. The PHY section 16 includes a PLL circuit 1 6a with high power consumption.

The CPU 11 executes a program loaded on the main memory 12 in the PC 1. A USB device 19, such as a USB memory, a hard disk drive, and a mouse, can be connected to the USB host controller 13 of the PC 1. The PC 1 can use the connected USB device 19 as a peripheral device.

The PLL circuit 16a generates a high-speed clock from a low-speed clock. The PLL circuit 16a is a circuit that needs to operate when a USB device of USB 2.0 type is connected, but that can be stopped in a suspended state defined in the USB standard. Thus, the state that the USB device of USB 2.0 type is connected is a mode state for data transfer between the USB device 19 and the CPU 11 using a clock signal generated by the PLL circuit 16a.

Although here, the bus to which the USB host controller 13 is connected is the internal bus 14 to which the CPU 11 is connected, the bus may be different from the internal bus 14 to which the CPU 11 is connected.

The interfaces 17 and 18 of the Link section 15 and the PHY section 16 are interfaces compliant with the UTMI+ standard (Revision 1.0). In the present embodiment, the USB 2.0 host controller 13 is configured by the PHY section 16 including an interface in the UTMI+ standard, and the PHY section 16 is a PHY section including a mode of transferring with a serial interface in a Full/Low speed mode (hereinafter, also called “full/low-speed mode”). A state in which a USB device of USB 1.1 type is connected is a mode state in which data is transferred between the USB device 19 and the CPU 11 without using a clock signal generated by the PLL circuit 16a.

In the present embodiment, the following two states are defined as states that can change the PLL circuit 16a of the PHY section 16 to a power saving state in a state other than the suspended state (hereinafter, also called “state A”) defined in the USB 2.0 standard.
State B: state of waiting for the connection of USB device (device connection waiting state)
State C: operation state in a full/low-speed mode (Full/Low Speed)

The USB host controller 13 of the present embodiment includes a controller that includes a function for shifting the PHY section 16 to the suspended state when one of the two states B and C defined as described above is detected and restoring the PHY section 16 from the suspended state when the detected state is changed.

FIG. 2 is a block diagram of an internal configuration of the USB host controller 13 including the controller. The USB host controller 13 includes the Link section 15, the PHY section 16, a controller 21, and an AND circuit 22.

The Link section 15 includes a suspend signal generating unit 23 as a power saving control circuit and a register unit 24. The controller 21 is a control circuit constituted of a hardware circuit including a counter 25 and a state machine unit 26.

The suspend signal generating unit 23 of the Link section 15 is a circuit configured to output a suspend signal SS as a predetermined signal when the suspended state defined by the USB 2.0 standard is detected. The suspend signal SS is a signal that becomes LOW when there is no data communication between the USB device 19 and the CPU 11 even though the USB device 19 is connected. The suspend signal SS is supplied to one of the input ends of the AND circuit 22.

The suspend signal generating unit 23 as a power saving control circuit generates the suspend signal SS for shifting to the power saving mode in accordance with, for example, an instruction from the CPU 11 when the suspended state (state A) defined by the USB 2.0 standard is set and outputs the suspend signal SS to the PHY section 16.

The PHY section 16 shifts to the suspended state when LOW of a suspend signal S from the AND circuit 22 is inputted and controls the PLL circuit 16a to stop the operation of the internal PLL circuit 16, for example, by stopping the power delivery to the PLL circuit 16a.

The register unit 24 includes a plurality of registers and registers values including values of internal registers that are mounted in the USB host controller 13 and defined by the EHCI standard.

In FIG. 2, the register unit 24 includes three registers r1, r2, and r3 that can hold one-bit data. The registers r1, r2, and r3 indicate the following contents.

Register r1: CONFIGFLAG bit of EHCI Operational Registers

Register r2: PORTSC.Port Owner bit of EHCI Operational Registers

Register r3: PORTSC.CCS bit of EHCI Operational Registers

The values of the registers [r1, r2, r3] indicate [1, 0, 0] in the state B, [1, 1, 0] in the state C, and [1, 0, 1] in the state A.

Usually, when the PC 1 is activated, the values of the registers [r1, r2, r3] are set to initial values [1, 0, 0]. When the USB device 19 is connected, the CPU 11 determines the type of the connected USB device 19, i.e., the USB 2.0 type or the USB 1.1 type. As a result of the determination, the CPU 11 changes the values of the registers [r1, r2, r3] to [1, 1, 0] if the USB device 19 is the USB 1.1 type and changes the values of the registers [r1, r2, r3] to [1, 0, 1] if the USB device 19 is the USB 2.0 type.

The controller 21 includes a counter 25. The controller 21 monitors the values of the internal registers in the register unit 24, counts a predetermined period by the counter 25, and detects whether the values of the registers of the register unit 24 are maintained for the predetermined period.

The controller 21 is a control circuit configured to output a suspend signal SC as a predetermined output signal to shift the PHY section 16 to the suspended state. The controller 21 as a hardware circuit includes a state machine unit 26 and monitors the values of the registers. The controller 21 outputs a LOW suspend signal SC for stopping the operation of the PLL circuit 16a to the PHY section 16 when the operation state of the USB host controller 13 is the states B and C. The suspend signal SC is usually HIGH and becomes LOW when the state is B and C.

As described above, the counter 25 is a counter configured to determine whether the register values hold the same values for a predetermined period. The count value becomes a predetermined value when the register values hold the same values for a predetermined period. Therefore, the register values are specified when the same values are held for a predetermined period, and the specified values are inputted to the state machine unit 26. The state machine unit 26 determines the operation state of the USB host controller 13 based on the values. Thus, the state machine unit 26 can detect whether the operation state of the USB host controller 13 has changed to the states B and C based on the values of the registers [r1, r2, r3] as the internal registers of the Link section 15.

More specific explanation will be described.

The device connection waiting state (state B) is established by satisfying the following conditions of the register values defined by the EHCI standard.

### [Condition 1-1: Device Connection Waiting State Detection Condition]

CONFIGFLAG of EHCI Operational Registers=1'b1,

PORTSC.Port Owner=1'b0, and

PORTSC.CCS bit=1'b0.

If the state of the condition 1-1 is maintained as the counter 25 in the controller 21 counts the state for a predetermined period of several ms, for example, more than 3 ms, the state is determined as the device connection waiting state (state B).

The operation state (state C) of the full/low-speed mode (Full/Low Speed) in the USB 1.1 is established by satisfying the following conditions of the register values.

### [Condition 1-2: Full/Low-Speed Mode State Detection Condition]

CONFIGFLAG of EHCI Operational Registers=1'b1,

PORTSC.Port Owner=1'b1, and

PORTSC.CCS bit=1'b0.

If the state of the condition 1-2 is maintained as the counter 25 in the controller 21 counts the state for a predetermined period of several ms, for example, more than 3 ms, the state is determined as the full/low-speed mode state (state C).

In the present embodiment, the case of detecting the two operation states is defined as a state in which the PHY section 16 is suspendable, and the state of the state machine unit 26 in the controller 21 is changed.

The state machine unit 26 supplies the LOW suspend signal SC to the other input end of the AND circuit 22 in accordance with the transition of the determined operation state. In other words, the state machine unit 26 outputs the LOW suspend signal SC when the transition of the operation state to the state B or C is detected.

The PHY section 16 inputs a line state signal (line_state[1:0]) LS as an output signal from the PHY section 16 defined by the UTMI+ standard to the controller 21 and the Link section 15. The line state signal herein is a two-bit signal indicating the state of DP/DM signals. The DP/DM signals are signals indicating the state of the USB bus.

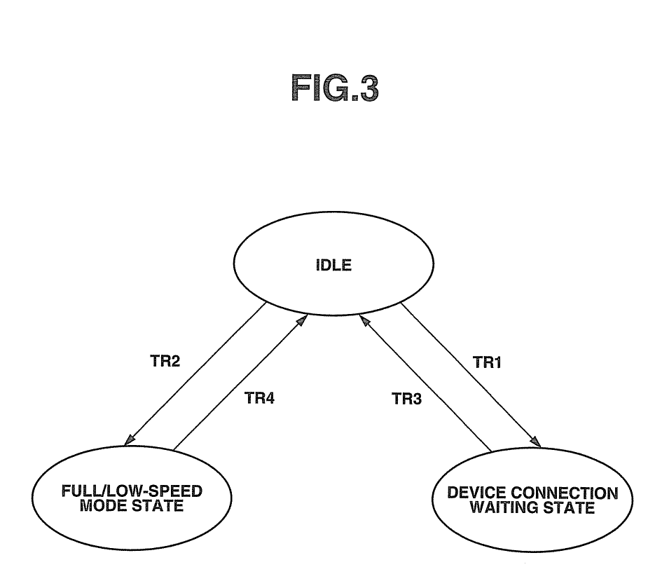

FIG. 3 is a state transition diagram for explaining a state transition in the state machine unit 26. Three operation states are defined here. One of the operation states is an idle state as an initial state, and in this operation state, the suspend signal S to the PHY section 16 is inactive, or HIGH. The state A is not shown in FIG. 3.

The second operation state is the state B, or the device connection waiting state, which is a state to be shifted to after the establishment of the device connection waiting state detection condition is detected in the idle state. The device connection waiting state is a state in which a device is not connected. The suspend signal SC is LOW in the device connection waiting state. In FIG. 3, an arrow TRI indicates the transition from the idle state to the state B.

The third operation state is the state C, or the full/low-speed mode state, which is a state to be shifted to after the establishment of the full/low-speed mode state detection condition is detected in the idle state. The suspend signal SC is LOW in the full/low-speed mode state. In FIG. 3, an arrow TR2 indicates the transition from the idle state to the state C.

When the operation state has changed from the idle state to the states B and C, the controller 21 makes the suspend signal SC LOW and activates the suspend signal S to the PHY section 16, or makes the suspend signal S LOW, to shift the PHY section 16 to the suspended state. In other words, the suspend signal S becomes LOW, and the PHY section 16 is switched to the suspended state in the device connection waiting state (state B) and the full/low-speed mode state (state C).

A control for restoring from the device connection waiting state or the full/low-speed mode state to the suspended state in the idle state is needed in the controller 21.

The condition for restoring from the device connection waiting state is as follows.

Condition 2-1: detect a new connection of a USB device in the device connection waiting state.

The condition for restoring from the full/low-speed mode state is as follows.

Condition 2-2: detect disconnection or pulling out of the USB device in the full/low-speed mode state.

The line state signal LS as an input signal from the PHY section 16 is used in addition to the register values of the EHCI standard to detect the establishment of the condition 2-1.

The line state signal LS is a signal defined by the UTMI+ standard and is a signal reflecting the state of the DP/DM of the USB bus. The line state signal LS is outputted through a circuit configured to detect the state of the DP/DM, if the USB device is connected when the PHY section 16 is in the suspended state. Therefore, the state of the DP/DM can be monitored by the line state signal LS even in the power saving mode in which the PLL circuit is stopped. The DP/DM signals are both 0 when the USB device is not connected, but one of the signals becomes 1 when the USB device is connected. Thus, the circuit configured to detect the state of the DP/DM uses the DP/DM signals to determine the establishment of the condition 2-1. The recovery condition 2-1 is established by satisfying the following state.

Condition 3-1: line state signal LS[1:0] is not 2'b00.

The operation state changes from the device connection waiting state to the idle state after the detection of the condition 3-1. In FIG. 3, an arrow TR3 indicates the transition from the device connection waiting state to the idle state.

The condition 2-2 is established when the internal register values of the EHCI standard satisfy the following condition.

Condition 3-2:

CONFIGFLAG of EHCI Operational Registers=1'b1

PORTSC.Port Owner=1'b0, and

PORTSC.CCS bit=1'b0.

The operation state changes from the full/low-speed mode state to the idle state after the detection of the condition 3-2. In FIG. 3, an arrow TR4 indicates the transition from the full/low-speed mode state to the idle state.

The operation state changes to the idle state after the establishment of the two conditions 3-1 and 3-2, and the suspend signal S to the PHY section 16 again becomes inactive, or goes into a HIGH state. As a result, the PLL 16a of the PHY section 16 restores from the power saving state.

For example, when a USB device compliant with USB 2.0 is connected in the device connection waiting state, the state changes from the device connection waiting state to the idle state. If the USB device is connected and there is no data to be transferred on the bus of the USB, the state shifts to the suspended state (not shown in FIG. 3) defined in USB standard, or the suspended state (state A) defined in the USB 2.0 standard.

When the USB device of USB 1.1 type is connected in the device connection waiting state, the operation state temporarily changes from the device connection waiting state to the idle state. However, when the USB device is determined as the USB device of USB 1.1 type, the state shifts from the idle state to the full/low-speed mode state (state C), and as described above, the PLL circuit 16a can be turned off.

In this state too, if the USB device of USB 1.1 type is connected and there is no data to be transferred on the bus of the USB, the state shifts to the suspended state (not shown in FIG. 3) defined by the USB standard.

Furthermore, the recovery condition 2 is established when the USB device compliant with USB 1.1 is pulled out in the full/low-speed mode state (state C). As a result, the operation state changes from the state C to the idle state and changes to the device connection waiting state (state B) when the state that the USB device is pulled out continues for a predetermined time.

An operation of the information processor 1 will now be described.

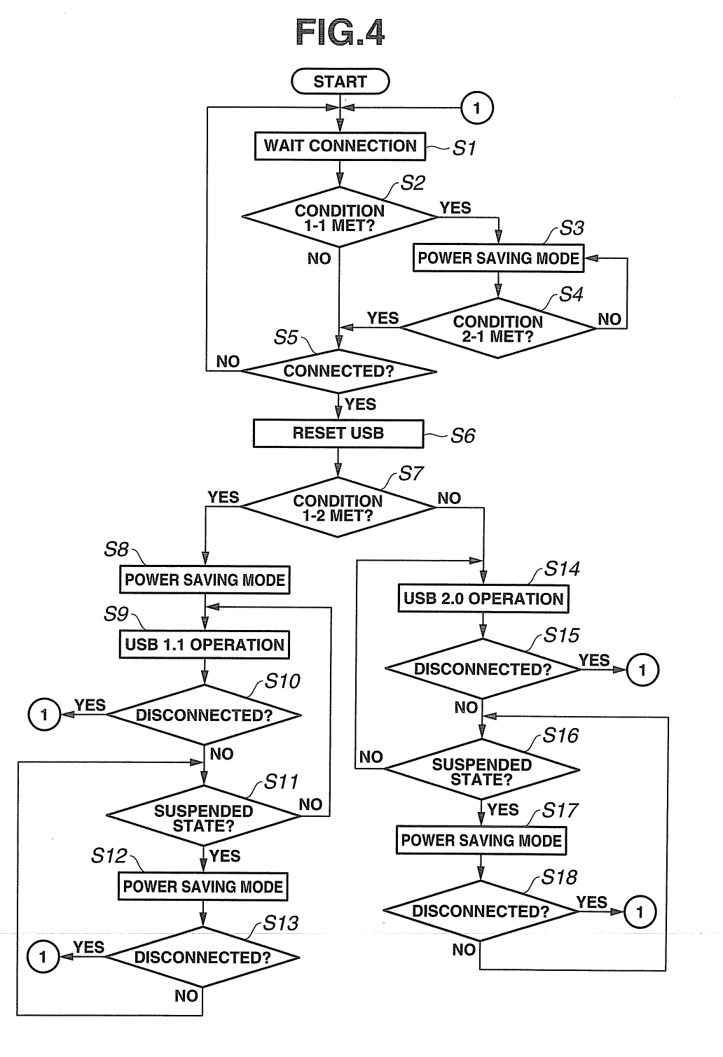

FIG. 4 is a flow chart of an example of a flow of a power saving control of the USB host controller in the information processor 1. The CPU 11 and the controller 21 execute the process of FIG. 4.

First, an operating system (OS) is activated when the power of the PC 1 is turned on, and the connection waiting state of the USB device 19 is set (step S1).

The controller 21 then determines whether the condition 1-1, or the device connection waiting state detection condition, is met (step S2).

If the controller 21 determines that the condition 1-1 is met, the operation state changes to the device connection waiting state (state B). The LOW suspend signal SC is outputted to set the power saving mode of stopping the operation of the PLL circuit 16a (step S3). As shown in FIG. 2, the AND circuit 22 outputs the LOW suspend signal S if one of the suspend signals SS and SC becomes LOW, or the PLL circuit 16a of the PHY section 16 stops.

When the power saving mode of stopping the PLL operation is set, the controller 21 determines whether a new connection of the USB device is detected in the condition 2-1, or the device connection waiting state (step S4).

If the condition 2-1 is not met in step S4, the step S4 is NO, and the process returns to step S3.

If step S2 is NO or step S4 is YES, the CPU 11 determines whether the USB device 19 is connected (step S5). The process returns to step S1 if the USB device 19 is not connected.

If the connection of the USB device 19 is detected, step S5 is YES, and the CPU 11 executes a USB reset process (step S6). The USB reset process includes a process for authenticating the type of the connected USB device, i.e. the USB 1.1 type or the USB 2.0 type.

After the USB reset process (step S6), the controller 21 determines whether the condition 1-2 is met (step S7).

If the USB device 19 is determined to be the USB 1.1 type in step S7, or the operation state is changed to the state C, the controller 21 sets the mode to the power saving mode that stops the operation of the PLL circuit 16a (step S8). The CPU 11 then executes a process corresponding to the operation of the USB 1.1 (step S9).

The controller 21 determines whether the USB device 19 is disconnected, or pulled out (step S10). The pulling out is determined by whether the condition 2-2 is met. The operation state changes to the idle state if the pulling out is detected, and when the state continues for a predetermined period, the operation state changes to the device connection waiting state (state B).

If the USB device 19 is disconnected, step S10 is YES, and the process returns to step SI.

If the USB device 19 is not disconnected, step S10 is NO, and the CPU 11 determines whether the state is the suspended state defined by the USB standard (step S11).

As described above, the suspended state defined by the USB standard is an idle state in which the USB device 19 is connected and there is no data to be transferred on the bus of the USB.

If the state is not the suspended state, step S11 is NO, and the process returns to step S9.

If the state is the suspended state, the CPU 11 sets the USB device to the power saving mode compliant with the USB standard (step S12).

The controller 21 then determines whether the USB device 19 is disconnected, or pulled out (step S13). The pulling out is determined by whether the condition 2-2 is met.

If the USB device 19 is disconnected, step S13 is YES, and the process returns to step S1.

If the USB device 19 is not disconnected, step S13 is NO, and the process returns to step S1.

On the other hand, if the USB device 19 is determined to be the USB 2.0 type in step S7, the CPU 11 executes a process corresponding to the operation of the USB 2.0 (step S14).

The controller 21 determines whether the USB device 19 is disconnected, or pulled out (step S15).

If the USB device 19 is disconnected, step S15 is YES, and the process returns to step S1.

If the USB device 19 is not disconnected, step S15 is NO, and the CPU 11 determines whether the state is the suspended state defined by the USB standard (step S16).

As described above, the suspended state defined by the USB standard is an idle state in which the USB device 19 is connected and the there is no data to be transferred on the bus of the USB.

If the state is not the suspended state, the step S16 is NO, and the process returns to step S14.

If the state is the suspended state, the CPU 11 sets the USB device to the power saving mode corresponding to the USB standard (step S17). The suspend signal generating unit 23 of the Link section 15 generates and outputs the suspend signal SS after the CPU 11 outputs a predetermined control signal to the USB host controller 13 to attain the power saving mode.

The controller 21 then determines whether the USB device 19 is disconnected, or pulled out (step S18).

If the USB device 19 is disconnected, step S18 is YES, and the process returns to step S1.

If the USB device 19 is not disconnected, step S18 is NO, and the process returns to step S16.

As described above, the controller 21 as hardware can shift the device connection waiting state or the full/low-speed mode state to the power saving state in the information processor 1 according to the present embodiment and can control the power saving in accordance with the operation state of the USB host controller.

Specifically, the USB host controller of the present embodiment goes into the power saving mode that stops the operation of the PLL circuit not only in the connection waiting state in which the USB device is not connected, but also in the state in which the USB device of the USB 1.1 type is connected.

### Second Embodiment

Although the controller includes a counter in the first embodiment, the controller includes three registers accessible by the CPU in the present embodiment. The present embodiment is different from the first embodiment in that the controller controls the power saving mode that stops the PLL circuit according to the contents of the registers written by the CPU.

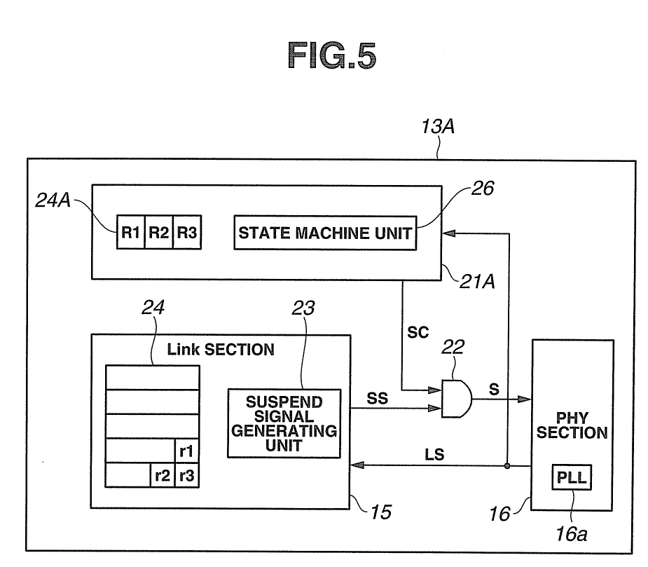

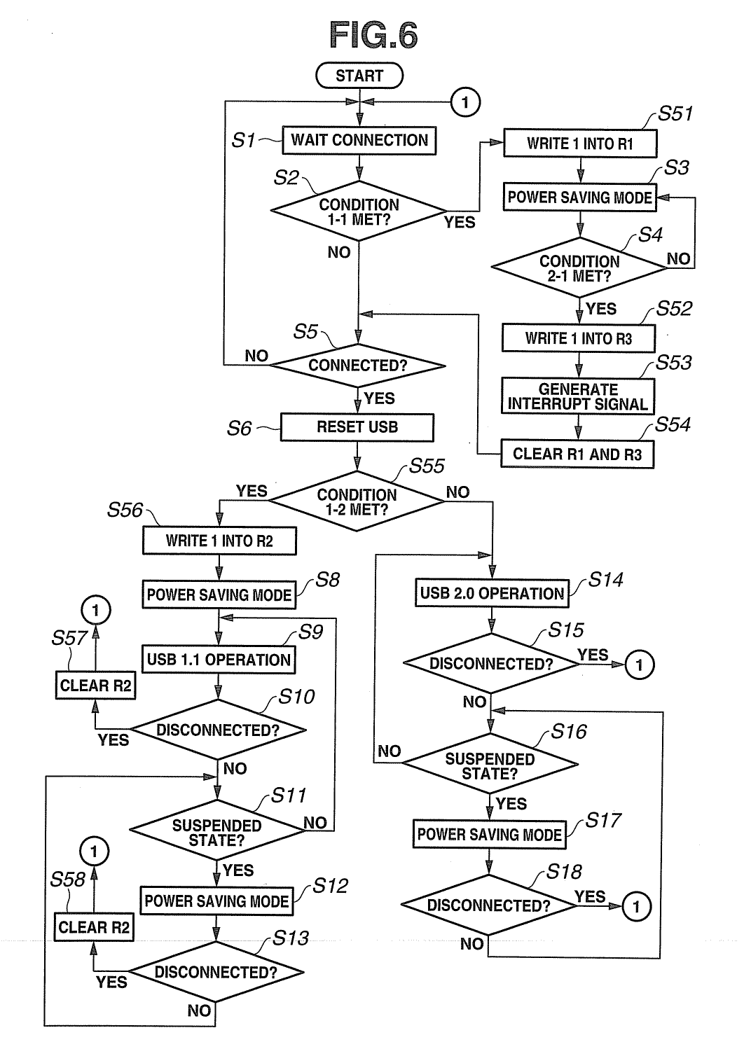

FIG. 5 is a block diagram of an internal configuration of a USB host controller 13A including the controller according to the present embodiment. The same constituent elements as in the first embodiment are designated with the same reference numerals in FIGS. 5 and 6, and the description will not be repeated.

A controller 21A includes a register circuit 24A accessible, or readable and writable, by the CPU 11. The register circuit 24A includes three registers R1, R2, and R3, each being a 1 bit register. More specifically, the CPU 11 writes and stores data corresponding to the operation states into the registers based on the values of the internal registers of the Link section 15. A software program executed by the CPU 11 detects the establishment of four conditions 1-1, 1-2, 2-1, and 2-2 described in the first embodiment.

The operation state in which the condition 1-1 is met, or the device connection waiting state, is detected by monitoring the state of PORTSC.CCS bit of EHCI Operational Registers defined by the EHCI standard. The PORTSC.CCS bit is a bit indicating the connection state of the USB device 19, and the USB device 19 is not connected if the bit indicates 1'b0 for a predetermined period.

If the CPU 11 counts PORTSC.CCS bit=1'b0 for a predetermined period, for example several ms, the CPU 11 determines that the operation state is the device connection waiting state (state B).

The CPU 11 writes “1” into the register R1 in the register group 24A in the controller 21A constituted of a hardware circuit if the establishment of the condition 1-1 is detected. The initial value of the register value of the register R1 is “0”, and the change of the bit from “0” to “1” implies that the condition of the transition TR1 of FIG. 3 is met.

Therefore, the operation state of the state machine unit 26 changes from the idle state to the device connection waiting state. Based on the data in the register circuit 24A, the controller 21A makes the suspend control signal SC LOW, makes the suspend signal S to the PHY section 16 active, or LOW, and shifts the PHY section 16 to the suspended state.

The CPU 11 detects the state in which the condition 1-2 is met, or the full/low-speed mode state, based on whether the register values defined by the EHCI standard satisfy the following condition.

### Condition 4:

CONFIGFLAG of EHCI Operational Registers=1'b1,

PORTSC.Port Owner=1'b1, and

PORTSC.CCS bit=1'b0, or

CONFIGFLAG=1'b0 and

PORTSC.CCS bit=1'b0.

The CPU 11 writes “1” into the register R2 in the register group 24A in the controller 21A if the establishment of the condition 1-2 is detected. The initial value of the register value of the register R2 is “0”, and the change of the bit from “0” to “1” implies that the condition of the transition TR2 of FIG. 3 is met. The operation state of the state machine unit 26 changes from the idle state to the full/low-speed mode state (state C). Based on the data in the register circuit 24A, the controller 21A makes the suspend control signal SC LOW, makes the suspend signal S to the PHY section 16 active, or LOW, and shifts the PHY section 16 to the suspended state.

In this way, the CPU 11 writes “1” into the register R1 or R2 when the establishment of the condition 1-1 or 1-2 is detected. The controller 21A monitors the content of the register R1 or R2 and controls the output of the suspend signal SC in accordance with the content.

Therefore, when the operation state changes from the idle state to the device connection waiting state or the full/low-speed mode state, the state machine unit 26 activates the suspend signal S to the PHY section 16 and shifts the PHY section 16 to the suspended state of the PLL operation termination power saving mode.

The CPU 11 further detects the condition 2-1, or the connection of the USB device 19, in the device connection waiting state in the following way.

The controller 21A changes the register R3 in the register group 24A to “1” when the state that both of the two bits of the line state signal LS are not “0” is detected. More specifically, the controller 21A is configured to input and monitor the line state signal LS and automatically writes “1” into the register R3 when both of the two bits of the line state signal LS are not “0”. The initial value of the register R3 is “0”. The controller 21A outputs a predetermined interrupt signal to the CPU 11 based on the change in the register R3.

The CPU 11 changes the bits of the registers R1 and R3 to “0” after detecting the interrupt signal. The change implies clearing of the factors of the generation of the interrupt signal.

The detection of the connection of the USB device 19 implies that the condition of the transition TR3 of FIG. 3 is met. The operation state of the state machine unit 26 is changed from the device connection waiting state to the idle state. As a result, the operation state of the state machine unit 26 is changed from the device connection waiting state to the idle state, the suspend signal S to the PHY section 16 is inactivated, and the PLL 16a of the PHY section 16 is shifted to the operation state.

The CPU 11 detects the condition 2-2, or the disconnection (or pulling out) of the USB device, in the full/low-speed mode state in the following way.

As in the first embodiment, the USB host controller 13A outputs an interrupt signal to the CPU 11 when disconnection, or pulling out, of the USB device 19 is detected during operation in the full/low-speed mode state, and the CPU 11 detects the interrupt.

Since the interrupt signal indicates that the USB device 19 is disconnected, the CPU 11, having detected the interrupt signal, determines that the condition 2-2 is met and changes the bit of the register R2 to “0”. The change implies that the condition of the transition TR4 of FIG. 3 is met. As a result, the operation state of the state machine unit 26 changes from the full/low-speed mode state to the idle state, the suspend signal S to the PHY section 16 is inactivated, and the PLL 16a of the PHY section 16 is shifted to the operation state.

An operation of the information processor of the present invention will now be described.

FIG. 6 is a flow chart of an example of a flow of the power saving control of the information processor. The CPU 11 executes the process of FIG. 6. In FIG. 6, the same processes as in FIG. 4 are designated with the same reference numerals, and the description will not be repeated.

The CPU 11 writes “1” into the register R1 if step S2 is YES (step S51). The controller 21A makes the suspend signal SC LOW and sets the mode to the power saving mode when the register R1 becomes “1” (step S3).

If the condition 2-1 is met, the CPU 11 writes “1” into the register R3 (step S52), generates and outputs an interrupt signal (step S53), and clears the registers R1 and R3 (step S54).

After the USB reset (step S6), whether the condition 4 is met is determined (step S55).

If the condition 4 is met, step S55 is YES, and the CPU 11 writes “1” into the register R2 (step S56). Since the register R2 is “1”, the controller 21A outputs the suspend signal SC as LOW to set the power saving mode that stops the operation of the PLL circuit 16a (step S8).

If the USB device 19 is disconnected, or pulled out (steps S10 and S13 YES), the register R2 is cleared and set to “0” (steps S57 and S58).

As described above, according to the present embodiment, the controller 21A includes three registers. The CPU 11 executes a software program for rewriting the contents of the registers according to the operation state, and the controller 21A outputs a suspend signal to stop the operation of the PLL circuit in accordance with the contents of the registers.

As a result, in the information processor according to the present embodiment, the CPU 11 can shift the state to the power saving state in two operation states, the device connection waiting state and the full/low-speed mode state. Therefore, the power can be saved in accordance with the operation state of the USB host controller.

More specifically, the USB host controller of the present embodiment shifts to the power saving mode of stopping the operation of the PLL circuit not only in the connection waiting state in which the USB device is not connected, but also in the state in which the USB device of USB 1.1 type is connected.

As described above, according to the information processor in the embodiments, the power can be saved by stopping the operation of the PLL circuit of the PHY section not only in the device waiting state in which the USB device is not connected to the USB host controller, but also in the full/low-speed mode state of the USB host controller, in addition to the conventional suspended state.

Although a PC has been described as an example of the information processor in the two embodiments, the PC includes a portable PC, and the information processor may be a device, such as a cell phone and a digital audio player, other than the PC.

As described above, according to the USB host controller, the information processor, and the program of the embodiments of the present invention, the power of the PLL circuit can be saved not only in the state of waiting for the connection of the USB device, but also in other states.

The components in the present specification are conceptual components corresponding to the functions of the embodiments and do not necessarily correspond one to one with specific hardware or software routines. Therefore, the embodiments of the present specification have been described by designing virtual circuit blocks (units) including the functions of the embodiments. The execution order of the steps of the procedures in the present embodiments can be changed without departing from the characteristics of the embodiments, and a plurality of steps can be executed simultaneously or the order can be changed in each execution.

All or part of the programs for executing the above described operations are recorded or stored in a portable medium, such as a flexible disk and a CD-ROM, or in a storage medium, such as a hard disk, as a computer program product. A computer reads program codes to execute all or part of the operations. Alternatively, all or part of the programs are distributed or provided through a communication network. The user can easily realize the information processor of the present invention by downloading the programs through the communication network to install the programs on the computer or by installing the programs on the computer from the recording medium.

The present invention is not limited to the embodiments, and various changes and modifications can be made without departing from the scope of the present invention.

What is claimed is:

1. A USB host controller comprising:
a power saving control circuit configured to generate a predetermined signal for stopping the operation of a PLL circuit and output the signal to a physical layer including the PLL circuit if there is no communication between a USB device and a CPU in a first mode state of using a clock signal generated by the PLL circuit to transfer data between the USB device and the CPU; and
a control circuit configured to generate the predetermined signal for stopping the operation of the PLL circuit and output the signal to the physical layer in a connection waiting state in which the USB device is not connected and in a second mode state of transferring the data between the USB device and the CPU without using the clock signal generated by the PLL circuit.

2. The USB host controller according to claim 1, wherein
the control circuit includes a state machine unit and outputs the predetermined signal to the physical layer when detecting that the state of the USB host controller has been changed to the connection waiting state and the second mode state.

3. The USB host controller according to claim 2, wherein
the control circuit is constituted of a hardware circuit and detects a transition to the connection waiting state and a transition to the second mode state.

4. The USB host controller according to claim 3, wherein
the control circuit detects the transition to the connection waiting state and the transition to the second mode state based on values of internal registers of a digital layer.

5. The USB host controller according to claim 3, wherein
the control circuit changes the state to an idle state of operating the PLL circuit and does not output the predetermined signal when detecting a connection of the USB device in the connection waiting state or detecting pulling out of the USB device in the second mode state.

6. The USB host controller according to claim 5, wherein
the control circuit detects the connection of the USB device in the connection waiting state based on a signal indicating a state of a USB bus and detects the pulling out of the USB device in the second mode state based on values of the internal registers.

7. The USB host controller according to claim 2, wherein
the control circuit is constituted of a hardware circuit and includes a register circuit, the register circuit storing data corresponding to the connection waiting state or the second mode state, and
the control circuit outputs the predetermined signal based on the data of the register circuit.

8. The USB host controller according to claim 7, wherein
the CPU writes the data of the register circuit.

9. The USB host controller according to claim 8, wherein
the CPU writes the data of the register circuit based on values of internal registers of a digital layer.

10. The USB host controller according to claim 7, wherein
the control circuit supplies a predetermined interrupt signal to the CPU when detecting a connection of the USB device in the connection waiting state or detecting pulling out of the USB device in the second mode state, and based on the predetermined interrupt signal, the CPU clears data of the register circuit, changes the state to an idle state of operating the PLL circuit, and does not output the predetermined signal.

11. The USB host controller according to claim 10, wherein
the control circuit detects the connection of the USB device in the connection waiting state based on a signal indicating a state of a USB bus and detects the pulling out of the USB device in the second mode state based on values of the internal registers.

12. An information processor comprising:
a CPU; and
a USB host controller comprising: a power saving control circuit configured to generate a predetermined signal for stopping the operation of a PLL circuit and output the signal to a physical layer including the PLL circuit if there is no communication between a USB device and the CPU in a first mode state of using a clock signal generated by the PLL circuit to transfer data between the USB device and the CPU; and a control circuit configured to generate the predetermined signal for stopping the operation of the PLL circuit and output the signal to the physical layer in a connection waiting state in which the USB device is not connected and in a second mode state of transferring the data between the USB device and the CPU without using the clock signal generated by the PLL circuit.

13. The information processor according to claim 12, wherein
the control circuit includes a state machine unit and outputs the predetermined signal to the physical layer when detecting that the state of the USB host controller has been changed to the connection waiting state and the second mode state.

14. The information processor according to claim 13, wherein
the control circuit is constituted of a hardware circuit and detects a transition to the connection waiting state and a transition to the second mode state.

15. The information processor according to claim 14, wherein
the control circuit detects the transition to the connection waiting state and the transition to the second mode state based on values of internal registers of a digital layer.

16. The information processor according to claim 14, wherein
the control circuit changes the state to an idle state of operating the PLL circuit and does not output the predetermined signal when detecting a connection of the USB device in the connection waiting state or detecting pulling out of the USB device in the second mode state.

17. The information processor according to claim 16, wherein
the control circuit detects the connection of the USB device in the connection waiting state based on a signal indicating a state of a USB bus and detects the pulling out of the USB device in the second mode state based on values of the internal registers.

18. The information processor according to claim 13, wherein
the control circuit is constituted of a hardware circuit and includes a register circuit, the register circuit storing data corresponding to the connection waiting state or the second mode state, and
the control circuit outputs the predetermined signal based on the data of the register circuit.

19. A control method of a USB host controller, the control method comprising:
generating a predetermined signal for stopping the operation of a PLL circuit and outputting the signal to a physical layer including the PLL circuit if there is no communication between a USB device and a CPU in a first mode state of using a clock signal generated by the PLL circuit to transfer data between the USB device and the CPU; and
generating the predetermined signal for stopping the operation of the PLL circuit and outputting the signal to the physical layer in a connection waiting state in which the USB device is not connected and in a second mode state of transferring the data between the USB device and the CPU without using the clock signal generated by the PLL circuit.

20. A storage medium configured to store a program for causing a computer to control a USB host controller, the storage medium comprising:
a first code unit configured to generate a predetermined signal for stopping the operation of a PLL circuit and output the signal to a physical layer including the PLL circuit if there is no communication between a USB device and a CPU in a first mode state of using a clock signal generated by the PLL circuit to transfer data between the USB device and the CPU; and
a second code unit configured to generate the predetermined signal for stopping the operation of the PLL circuit and output the signal to the physical layer in a connection waiting state in which the USB device is not connected and in a second mode state of transferring the data between the USB device and the CPU without using the clock signal generated by the PLL circuit.
